(19) United States
(12) Patent Application Publication
(10) Pub. No.: US 2025/0012333 A1
(43) Pub. Date: Jan. 9, 2025

(54) DISC BRAKE ARRANGEMENT AND BRAKE DUST PARTICLE FILTER

(71) Applicants: MANN+HUMMEL GMBH, Ludwigsburg (DE); VOLKSWAGEN AKTIENGESELLSCHAFT, Wolfsburg (DE)

(72) Inventors: Tobias Wörz, Leutenbach (DE); Benedikt Weller, Steinheim (DE); Klaus Mack, Hardthausen (DE); Klaus Gehwolf, Mamming (DE); Theodor Rockinger, Marklkofen (DE); Steffen Pfannkuch, Ludwigsburg (DE); Lukas Bock, Bietigheim-Bissingen (DE); Karl-Friedrich Kaufmann, Gifhorn (DE)

(21) Appl. No.: 18/272,313

(22) PCT Filed: Dec. 20, 2021
(86) PCT No.: PCT/EP2021/086806

§ 371 Date: Jul. 13, 2023

(30) Foreign Application Priority Data
Jan. 14, 2021 (DE) 10 2021 200 322.2

(51) Int. Cl. F16D 65/00; F16D 55/225; F16D 65/02; F16D 65/12

(52) U.S. Cl. CPC F16D 65/0031; F16D 55/225; F16D 65/128; F16D 2065/1328

(57) ABSTRACT

A disc brake assembly including a brake disc, a brake caliper assembly with a brake caliper, and a brake dust particle filter with a filter housing and a filter medium arranged in sections in the filter housing, wherein the filter medium extends beyond the filter housing in the circumferential direction of the brake disc and abuts against the brake caliper assembly. A brake dust particle filter for such a disc brake assembly is included, including a filter housing and a filter medium arranged in sections in the filter housing, which extends beyond the filter housing in the circumferential direction.

### RELATED APPLICATIONS

The present application claims priority to International Patent Application No. PCT/EP2021/086806 to Wörz, et al., titled “Disk Brake Arrangement and Brake Dust Particle Filter”, filed Dec. 20, 2021, which claims priority to German Patent App. No. DE 10 2021 200 322.2, filed Jan. 14, 2021, the contents of each being incorporated by reference in their entirety herein.

### FIELD OF TECHNOLOGY

The present disclosure relates to a disc brake assembly comprising a brake disc and a brake caliper assembly with a brake caliper. The present disclosure also relates to a brake dust particle filter.

### BACKGROUND

Brake abrasion, so-called brake dust, contributes to the emission of fine particles into the environment by motor vehicles. The abrasion consists primarily of particles that have been worn off from a brake disc and brake pads. In addition to environmental pollution, brake dust leads to persistent contamination that can impair the function of the brake and adjacent components. In particular, deposits of brake dust on alloy wheels are also considered aesthetically disturbing.

A collecting device for brake dust of a disc brake is known as DE 10 2010 053 879 A1. The disc brake comprises a brake disc, a brake caliper, and at least one brake pad. The brake pad has an encapsulation that at least partially surrounds the brake pad. The encapsulation has a chamber into which brake dust can be directed during a braking operation, so that it deposits there.

Aspects of the present disclosure are directed to reducing the entry of brake dust into the environment of a disc brake.

### SUMMARY

Some aspects of the present disclosure relating to a disc brake assembly and a brake dust particle filter are illustrated in the features specified in the independent claims. Preferred examples and embodiments are disclosed in the respective dependent requirements and in the description.

In some examples, a disc brake assembly is disclosed, wherein the disc brake assembly includes a brake disc and a brake caliper assembly with a brake caliper. Directions such as radial, axial, or circumferential as used herein refer to an axis of rotation of the brake disc. The brake caliper partially surrounds the brake disc. The brake caliper assembly may also include at least two brake pads arranged on different sides of the brake disc. The brake pads can be pressed against a friction ring of the brake disc by at least one brake piston of the brake caliper.

In some examples, the disc brake assembly further includes a brake dust particle filter with a filter housing and a filter medium. The filter housing can partially surround the brake disc. The filter housing may be configured to be U-shaped in cross-section. The filter housing and the brake caliper can be separate components. The filter medium serves to retain and collect brake dust particles. The filter medium is arranged in sections within the filter housing.

The brake dust particle filter can be configured as a brake dust particle filter as disclosed herein. Features of the brake dust particle filter according to the present disclosure can be provided in the brake dust particle filter of the disc brake assembly.

In some examples, the filter medium may extend over the circumference of the brake disc and abuts on the brake caliper assembly. In particular, the filter medium can bridge a gap between the filter housing and the brake caliper assembly. The protruding section of the filter medium can guide an air stream laden with brake dust particles from the brake caliper into the filter housing. In the filter housing, the brake dust particles can be effectively separated in the filter medium. In the area of the protrusion of the filter medium, brake dust particles can be prevented from escaping between the filter housing and the brake caliper assembly into the environment. The protrusion of the filter medium beyond the filter housing abutting tightly on the brake caliper assembly increases the separation efficiency of the brake dust particle filter, as the sealing of the interface is improved, resulting in fewer of the to be separated particles entering the environment. The disc brake assembly according to the invention releases brake dust particles into its environment to an extremely low extent.

In some examples, the filter medium can overlap with the brake caliper assembly in the circumferential direction. In other words, when viewed in the radial direction, the filter medium and the brake caliper assembly can be arranged in a stacked manner, with at least partial contact in the overlapping areas. This allows for a particularly effective sealing of the filter housing against the brake caliper assembly.

It can be provided that the filter medium abuts on the brake caliper assembly in elastic tension. The elastic tension prevents the filter medium from lifting off the brake caliper assembly during vibrations, such as when driving a vehicle equipped with the disc brake assembly. This is particularly effective for reducing the entry of brake dust particles into the vicinity of the disc brake assembly.

Alternatively or additionally, it can be provided that the filter medium is malleably deformed by abutting on the brake caliper assembly. Through the malleable deformation, the filter medium can conform to a contour of the brake caliper assembly, particularly over larger length sections. This also reduces the undesired escape of brake dust particles. In the case of malleable deformation of the filter medium, an additional elastic tension of the filter medium against the brake caliper assembly is typically provided to ensure mutual contact.

In some examples, the filter medium may extend over a circumferential section of the lateral surface of the brake disc. In other words, the filter medium arches over a radial outer circumferential section of the brake disc. Typically, due to the rotation of the brake disc, an airflow directed radially outward is generated, allowing a significant amount of brake dust particles to be retained on the outer circumference of the brake disc. Preferably, at least a portion of the circumferential wall of the filter housing can be lined with the filter medium.

Alternatively or additionally, the filter medium can extend in the radial direction, preferably on both sides, against the brake disc. In other words, the filter medium extends over one or both friction surfaces of the friction ring of the brake disc. In a particular embodiment, opposing side walls of the filter housing can be lined with the filter medium.

In some examples, it may be provided that the filter medium protrudes beyond an end edge of the circumferential wall facing the brake caliper assembly and/or at least one of the side walls of the filter housing. When the filter medium protrudes at the end edge of the circumferential wall, the aforementioned overlapping with the brake caliper assembly in the radial direction occurs. If the filter medium protrudes over the end edge of at least one of the side walls, the overlapping with the brake caliper assembly occurs in the axial direction. It may be advantageous to have the filter medium protrude over both the end edge of the circumferential wall and the end edge of at least one of the side walls, as this further improves the sealing of the brake caliper interface.

In some examples, the filter housing can be ring segment-shaped and have a receiving area that encompasses the brake disc within a predetermined angular range. The predetermined angular range can be at least 20°, and particularly at least 30°, for example, at least 40° of the circumference of the brake disc. The filter housing preferably encompasses the brake disc on both sides, i.e., on the side of each of the two friction surfaces. For this purpose, the filter housing can essentially have a U-shaped configuration in longitudinal section (relative to a rotational axis of the brake disc).

The brake caliper assembly may have a brake caliper holder that holds the brake caliper. The brake caliper can be axially movable on the brake caliper holder, meaning it can be designed as a floating caliper. The filter medium can be in contact with the brake caliper holder. Particularly, if the brake caliper holder has a holding section located behind the brake caliper in the rotational direction of the brake disc, where the filter medium abuts, it improves the dust-tight coupling of the brake dust particle filter to the brake caliper assembly. A brake pad can be supported on the holding section of the brake caliper holder. The brake caliper holder and the brake caliper are strictly separate components. The brake caliper holder and the filter housing can be separate components.

Alternatively or in addition to abutting on the brake caliper holder, it can be provided that the filter medium abuts on the brake caliper. This can also cover a gap between the brake caliper and the filter housing or a brake caliper holder with the filter medium. In particular, if the brake caliper is a fixed caliper and the brake caliper assembly does not have a separate brake caliper holder, the filter medium can directly abut on the brake caliper.

The brake disc can be an internally ventilated brake disc. This improves the thermal capacity of the disc brake assembly.

The filter housing can have at least one ventilation opening. Air pushed by the rotation of the brake disc into the filter housing can escape through the ventilation openings, preventing air with brake dust particles from flowing past the brake dust particle filter.

In some examples, at least one ventilation opening opens the filter housing in the radial direction. In other words, the ventilation opening allows air to flow out of the filter housing, away from the lateral surface of the outer circumference of the brake disc. In particular, an internally ventilated brake disc promotes the flow of air radially outward.

In some examples, a minimum of one ventilation opening is covered by the filter medium. This allows the brake dust particles carried by the air flowing through the filter housing to be retained in the brake dust particle filter.

Also falling within the scope of the present disclosure is a motor vehicle with a disc brake assembly. In some examples, the brake disc may be held on a wheel hub of the motor vehicle. The brake caliper assembly, especially a brake caliper holder of the brake caliper assembly, can be held on a wheel carrier of the motor vehicle.

Furthermore, the present disclosure includes a brake dust particle filter for a disc brake assembly as described herein. Features of the brake dust particle filter of the disc brake assembly can be provided in the brake dust particle filter according to the present disclosure.

In some examples, the brake dust particle filter includes a filter housing and a filter medium arranged sectionally in the filter housing. The filter medium may extend beyond the filter housing in the circumferential direction. The extension of the filter medium allows the filter housing to tightly abut on a brake caliper assembly, where the extension of the filter medium abuts on the brake caliper assembly.

The filter medium may incorporate a metal fiber fleece, and may be configured as a metal fiber fleece, in some examples. A metal fiber fleece exhibits high temperature resistance, enabling it to withstand the temperatures encountered in a disc brake. Additionally, a metal fiber fleece allows for the effective interception of brake dust particles from an airflow. A metal fiber fleece also has the capacity to absorb a large quantity of brake dust particles.

Alternatively or additionally, the filter medium may consist of or include other temperature-resistant materials, such as a glass fiber fleece and/or ceramic fiber fleece.

The filter medium may extend beyond the filter housing in the circumferential direction by at least 3 mm, preferably by at least 10 mm, and particularly preferably by at least 15 mm. This ensures a reliable brake dust particle-tight abutment of the filter housing on a brake caliper assembly.

### BRIEF DESCRIPTION OF THE DRAWINGS

Further features and advantages of the present disclosure will become apparent from the following detailed description of an embodiment of the invention, from the patent claims, and from the drawings, illustrating details of the present disclosure. The previously mentioned and further illustrated features may be realized individually or in any suitable combination in variations of the invention. The features shown in the drawings are illustrated in such a way that the details according to the invention can be clearly seen. The drawings illustrate:

FIG. 1 shows a disc brake assembly including a brake dust particle filter, wherein a filter medium protrudes from a filter housing and abuts on a brake caliper holder, in a schematic perspective view, according to some aspects of the present disclosure.

FIG. 2 depicts the disc brake assembly of FIG. 1 in a schematic sectional view, according to some aspects of the present disclosure.

### DETAILED DESCRIPTION

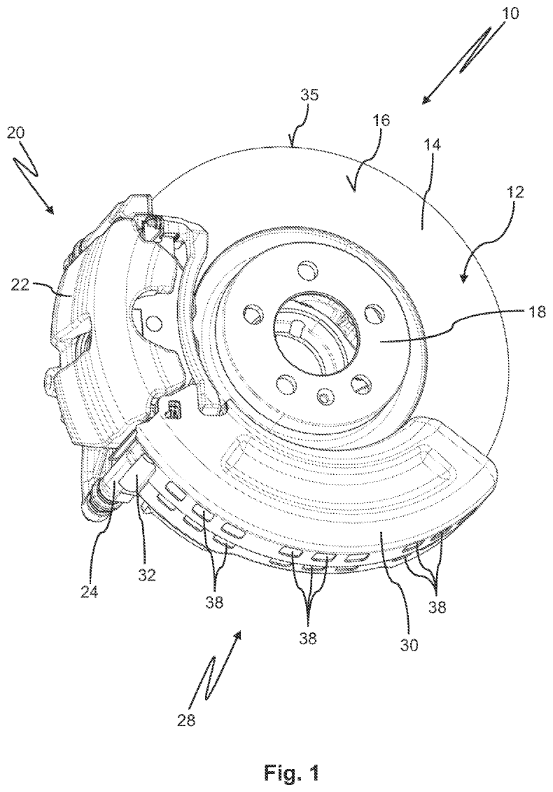

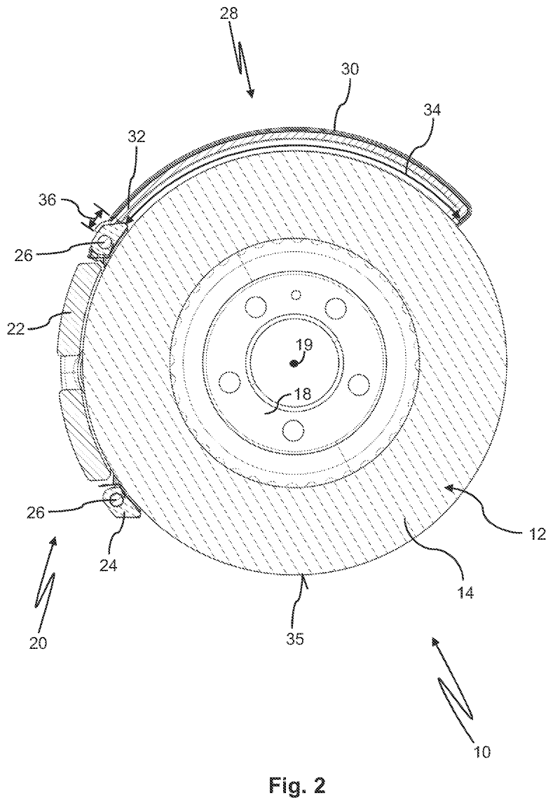

The example of FIG. 1 depicts a disc brake assembly 10 in a schematic perspective view. The disc brake assembly 10 comprises a brake disc 12. The brake disc 12 may be formed with a friction ring 14 having two opposing friction surfaces 16, of which only one is visible in FIG. 1, and a mounting portion 18 for attaching the brake disc 12 to a wheel hub (not shown). In FIG. 2, the disc brake assembly 10 is shown in a schematic sectional view with the cutting plane passing through the friction ring 14 of the brake disc 12. The brake disc 12 is rotatable about an axis of rotation 19. The brake disc 12 may be internally ventilated, with ventilation channels (not shown) formed in the friction ring 14.

The disc brake assembly 10 also includes a brake caliper assembly 20. The brake caliper assembly 20 comprises a brake caliper 22 and a brake caliper holder 24. The brake caliper 22 is held on the brake caliper holder 24. In this embodiment, the brake caliper 22 is configured as a floating caliper. The brake caliper 22 is movably guided in the axial direction on the brake caliper holder 24 via guide pins 26, as shown in FIG. 2. The brake caliper holder 24 serves to attach the brake caliper assembly 20 to a wheel carrier (not shown).

The disc brake assembly 10 further includes a brake dust particle filter 28. The brake dust particle filter 28 comprises a filter housing 30 and a filter medium 32. The filter medium 32 can be a metal fiber fleece. The filter medium 32 is partially arranged within the filter housing 30. The filter housing 30 may be U-shaped in cross-section. The filter housing 30 extends over a circumferential portion 34 (see FIG. 2) of a circumferential surface 35 above the brake disc 12 and encompasses (with the legs of its U-shaped cross-section) the friction surfaces 16 of the friction ring 14 (see FIG. 1).

The filter medium 32 extends over the (radially outer) circumferential portion 34 on the brake disc 12. In other words, the filter medium 32 partially covers the circumferential surface 35 of the brake disc 12. Additionally, the filter medium 32 can extend partially over the two friction surfaces 16 of the friction ring 14. For this purpose, the filter medium 32 can be U-shaped within the filter housing 30.

The filter medium 32 protrudes beyond the filter housing 30 in the circumferential direction. In other words, the filter medium 32 extends outwards from the filter housing 30 in the circumferential direction. A length 36 of the filter medium's 32 overhang, measured in the circumferential direction (see FIG. 2), can be at least 12 mm. The overhang of the filter medium 32 is formed on the outer circumferential part of the filter medium 32; in other words, the overhang of the filter medium 32 extends in the circumferential direction over the radially outer circumferential surface 35 of the brake disc 12. Additionally, it could be provided that the filter medium 32 also protrudes beyond the filter housing 30 towards the brake caliper assembly 20 in the area of the friction surfaces 16 (not shown in detail).

The portion of the filter medium 32 protruding from the filter housing 30 abuts on the brake caliper assembly 20. In this case, the filter element 32 abuts against the brake caliper holder 24. The filter medium 32 thereby bridges a gap between the filter housing 30 and the brake caliper holder 24. For a preferably laminar contact with the brake caliper assembly 20, the filter element 32 can be elastically and, in particular, malleably deformed, especially at the edge of the filter housing 30. The filter medium 32 can extend in the circumferential direction over a portion of the brake caliper assembly 20. In the illustrated embodiment, the filter medium 32 overlaps the brake caliper holder 24 in the circumferential direction.

The filter housing 30 may have multiple vent openings 38, as shown in FIG. 1. The vent openings 38 as shown are radially located on the outer side of the filter housing 30. The vent openings 38 allow an air flow to exit the filter housing 30, with the air flow having a radial velocity component.

The vent openings 38 are covered by the filter medium 32. The filter medium 32 extends on the inside of the filter housing 32, spanning over the vent openings 38. With the airflow, particularly driven by the ventilation channels of the ventilated brake disc 12, being directed into the filter housing 30, brake dust particles are carried along. The vent openings 38 allow the airflow to exit the filter housing 30. Meanwhile, the filter medium 32 that covers the vent openings 38 traps the brake dust particles. In this way, the brake dust particles are collected in the brake dust particle filter 28, specifically in its filter medium 32. The guidance of the airflow through the vent openings 38 thus increases the separation efficiency of the brake dust particle filter 28.

### LIST OF REFERENCE NUMERALS

Disc brake assembly 10
Brake disc 12
Friction ring 14
Friction surfaces 16
Mounting section 18
Axis of rotation 19
Brake caliper assembly 20
Brake caliper 22
Brake caliper holder 24
Slide pins 26
Brake dust particle filter 28
Filter housing 30
Filter medium 32
Circumferential section 34
Outer surface 35
Length 36 of the protrusion
Vent openings 38

1-17. (canceled)

18. A disc brake assembly, comprising:
a brake disc;
a brake caliper assembly comprising a brake caliper; and
a brake dust particle filter comprising a filter housing and a filter medium arranged in the filter housing in sections, wherein the filter medium protrudes in the circumferential direction of the brake disc beyond the filter housing and is in sealing abutment to the brake caliper assembly.

19. The disk brake assembly according to claim 18, wherein the filter medium is configured to overlap with the brake caliper assembly in the circumferential direction.

20. The disk brake assembly according to claim 18, wherein the filter medium is configured to abut in elastic tension against the brake caliper assembly.

21. The disk brake assembly according to claim 18, wherein the filter medium is configured to be malleably deformed by abutting to the brake caliper assembly.

22. The disk brake assembly according to claim 18, wherein the filter medium is configured to extend over a circumferential portion of a surface of the brake disc, and wherein a circumferential wall of the filter housing is at least partially lined with the filter medium.

23. The disk brake assembly according to claim 22, wherein the filter medium is configured to protrude beyond an end edge of the circumferential wall facing the brake caliper assembly and/or at least one of side walls of the filter housing

24. The disk brake assembly according to claim 18, wherein the filter medium is configured to extend in a radial direction on at least one side of the brake disc, and wherein opposite side walls of the filter housing are at least partially lined with the filter medium.

25. The disk brake assembly according to claim 18, wherein the filter housing is ring segment-shaped and comprises a receiving area that engages the brake disc in a predetermined angular range, comprising at least 20° of the circumference of the brake disc.

26. The disk brake assembly according to claim 18, wherein the brake caliper assembly comprises a brake caliper holder on which the brake caliper is held in an axially movable manner.

27. The disk brake assembly according to claim 18, wherein the filter medium is configured to abut to the brake caliper holder.

28. The disk brake assembly according to claim 18, wherein the filter medium is configured to abut to the brake caliper.

29. The disk brake assembly according to claim 18, wherein the brake disc comprises an internally ventilated brake disc.

30. The disk brake assembly according to claim 18, wherein the filter housing comprises at least one ventilation opening, preferably wherein the at least one ventilation opening is configured to open the filter housing in the radial direction.

31. The disk brake assembly according to claim 30, wherein the at least one ventilation opening is configured to be covered by the filter medium.

32. A brake dust particle filter for a disc brake assembly, comprising:
a filter housing; and
a filter medium configured in sections in the filter housing, the filter medium being configured to extend beyond the filter housing in the circumferential direction.

33. The brake dust particle filter of claim 32, wherein the filter medium comprises one of a metal fiber fleece, a glass fiber fleece, or a ceramic fiber fleece.

34. The brake dust particle filter of claim 32, wherein the filter medium is configured to extend beyond the filter housing in the circumferential direction by at least 3 mm.

35. A disc brake assembly, comprising:
a brake disc;
a brake caliper assembly comprising a brake caliper; and
a brake dust particle filter comprising a filter housing and a filter medium arranged in the filter housing in sections, wherein the filter medium protrudes in the circumferential direction of the brake disc beyond the filter housing and is in sealing abutment to the brake caliper assembly,
and wherein the filter medium is configured to overlap with the brake caliper assembly in the circumferential direction.

36. The disk brake assembly of claim 35, wherein the filter medium is configured to abut in elastic tension against the brake caliper assembly.

37. The disk brake assembly of claim 35, wherein the filter medium is configured to be malleably deformed by abutting to the brake caliper assembly.
